(19) United States
(12) Patent Application Publication
(10) Pub. No.: US 2011/0055164 A1
(43) Pub. Date: Mar. 3, 2011

(54) METHOD AND SYSTEM FOR MAINTAINING DATA RECOVERABILITY

(75) Inventors: Eric Justin Gould Bear, Austin, TX (US); David Bouteruche, Austin, TX (US); Stephane Debroutelle, Lambersart (FR); Christian Leman, Austin, TX (US); Mark Benjamin Power-Freeman, Austin, TX (US); Jan Moorman, Austin, TX (US); Vasken N. Sayre, Austin, TX (US)

(73) Assignee: SOFTTHINKS SAS, Villeneuve d'Ascq (FR)

(21) Appl. No.: 12/553,579

(22) Filed: Sep. 3, 2009

(51) Int. Cl. G06F 17/30

(52) U.S. Cl. 707/678; 707/E17.007

(57) ABSTRACT

A method and system for maintaining data recoverability of a computer system coupled to a storage device storing data objects includes identifying at least one recoverability parameter associated with the storage device. A recoverability index is calculated based on a recoverability parameter. The recoverability index may reflect the recoverability of the computer system from data loss. The recoverability index may be continuously calculated and evaluated. Recoverability actions, such as performing a backup operation, may be performed in response to a value associated with the recoverability index.

### BACKGROUND

1. Field of the Disclosure

The present disclosure relates to the backup of storage devices and, more particularly, to maintaining recoverability of computer systems having storage devices.

2. Description of the Related Art

Backup systems can provide a level of security to a computer system by enabling recoverability of stored data objects on storage resources, such as a storage device coupled to the computer system. During usage of the computer system, the state of the storage device may change continuously. Data objects stored on the storage device may be added, deleted, or modified. A backup operation may generate a backup copy of data objects that can be used to recover original data objects. The schedule of a backup operation may not be correlated with the actual usage of the computer system, resulting in a lower recoverability than is desired.

### BRIEF DESCRIPTION OF THE DRAWINGS

FIG. 1 is a block diagram of selected elements of an embodiment of a backup system;

FIG. 2 is a flow diagram of selected elements of an embodiment of a backup method;

FIG. 3 is a flow diagram of selected elements of another embodiment of a backup method; and

FIG. 4 is a diagram of selected elements of an embodiment of an exemplary computing device.

### DESCRIPTION OF THE EMBODIMENT(S)

Backup systems are used to generate backup copies of original data associated with computer systems. A measure of the ability to restore, or recover, original data using backup data is referred to herein as “recoverability.” Accordingly, recoverability of a storage device or a computer system refers to the extent recoverable backup data associated with the storage device or computer system has been generated. As used herein, a “data object” refers to an individual portion of data, or a data structure, that may be stored on a storage device. A data object may refer to an addressable storage location on the storage device, such as a particular sector. A data object may refer to a file system object created by a file system installed on the storage device (i.e., a file or a directory). A data object may also collectively refer to a plurality of data portions, or other data objects.

In theory, generating the backup copy reduces the risk of lost original data, because the backup copy can then be used to restore the original data. However, practical limits on the actual risk reduction attained with backup systems may arise from various factors. In reality, the backup system may be constrained in the ability to generate backup copies. Backup constraints, along with a corresponding loss of recoverability, may arise from limited resource allocation, such as the finite availability (e.g., for scheduling) of a backup server accessing a large number of client systems. Other constraints may involve performance factors, such as the time required to perform a complete backup operation, during which original data may change or be newly created, which may lower recoverability.

Furthermore, certain types of risk, or consequences, of data loss may not be evenly distributed across the original data. That is, certain portions of the original data may cause much greater damage if lost, which may lower the overall recoverability of a computer system. The damage from data loss may be secondary, for example, resulting from the unavailability of capital investments, or from lost productivity of human resources, either of which may directly depend on the lost data. Also, some data objects in the original data may experience a much higher rate of access than other data objects, which may lower recoverability for such data objects in a fixed-interval backup scheme. Certain user-defined data objects may be designated as being significantly more valuable than other data objects, and may thus be disproportionately represented in the overall system recoverability assessment. Additionally, there may be certain risks associated with the location or type of backup medium on which the backup copy is stored. For example, if the only available backup copy is located on the same storage device as the original data, then a failure of that storage device may cause both the original and backup data to be lost. Thus, storage of the backup copy on a different storage device may improve recoverability.

As described in detail below, a recoverability index may be generated to provide a measure of recoverability of a computer system. The recoverability index may be generated based on at least one of a variety of recoverability parameters, representing different factors associated with the computer system. In certain embodiments, a plurality of user-defined recoverability parameters may be used to calculate a recoverability index. In some embodiments, certain recoverability parameters may be weighted relative to other recoverability parameters that constitute the recoverability index. Certain recoverability parameters may be associated with particular data objects, rather than be affected by all the original data associated with the computer system. The recoverability index may still further include recoverability parameters associated with different storage devices, which may make different contributions. For example, a removable storage media used to store data objects may be considered a lower risk than a fixed hard disk, because the removable storage media may be physically stored in a different location from the computer system. Similarly, a storage-area network (SAN) may also make a different contribution to the recoverability index than other types of storage devices.

The recoverability index may be calculated continuously, periodically, or from time to time during use of the computer system, so as to provide a real-time indication of recoverability of the computer system. Such a monitoring of the recoverability index may be used to prevent recoverability associated with the computer system from falling below a desired level, for example, by performing a recoverability action. In one embodiment, the recoverability index is represented on a percent scale, with a value of 0 to 100 percent.

The recoverability index may be further compared against at least one threshold value for determining a potential recoverability action. Different threshold values may represent different ranges, or zones, on a scale associated with the recovery index. Each zone may be associated with one or more recoverability actions. In particular embodiments, the recoverability index may comprise a contribution from a number of individual recoverability parameters, along with additional rules or weightings from certain parameters, or groups of parameters, as desired. Further, the recoverability index may be logged with a timestamp and be used for historical analysis of the backup system.

In one aspect, a disclosed method for determining a recoverability state of a storage device includes identifying at least one recoverability parameter, and evaluating the storage device with respect to the recoverability parameter. The method may further include calculating a recoverability index based at least in part on the recoverability parameter, the recoverability index indicating the recoverability state of the first storage device, and performing a recoverability action based on the recoverability index.

In certain embodiments, the recoverability action may include at least one of: outputting the recoverability index, displaying the recovery index, issuing a warning message, suggesting a recoverability action, confirming a recoverability action, and performing a backup operation. The storage device may be coupled to a computer system. The storage device may represent a first storage device and a method of performing a recoverability action may further include performing a backup operation of data objects stored on the first storage device, the backup operation including generating a backup copy of the data objects. The backup copy may be stored on a second storage device different from the first storage device. Performing the recoverability action may be initiated based on a difference between a threshold value and the value of the recoverability index. A plurality of different threshold values may be associated with corresponding individual recoverability actions. Calculating the recoverability index may be performed at regular intervals. The recoverability action may include blocking user input associated with the storage device until a backup operation involving the storage device has been performed.

In some embodiments, the method may further include logging the value associated with the recoverability index along with a timestamp. Calculating the recoverability index may include weighting a first recoverability parameter relative to a second recoverability parameter. A plurality of recoverability parameters may be identified, while a first recoverability parameter is indicative of a location of a previously created backup copy of data objects stored on the storage device, and while a second recoverability parameter is indicative of a number of data objects stored on the storage device that have been modified subsequent to a prior backup operation on the storage device.

In a further aspect, a disclosed computer system may include a processor, a storage device configured for storing data objects, and memory media accessible to the processor. The memory media may include processor executable instructions including object code and/or processor compileable instructions including source code. The term processor useable instructions as used herein encompasses processor executable and processor compileable instructions. The processor useable instructions may include instructions to identify at least one recoverability parameter associated with the storage device, calculate a recoverability index value for the storage device based on the at least one recoverability parameter, and trigger a recoverability action for data objects stored on the storage device based on the recoverability index value.

The recoverability action may further include processor useable instructions to output the recoverability index, display the recovery index, issue a warning message, suggest a further recoverability action, confirm a further recoverability action, perform a backup operation, or block user input associated with the storage device until a backup operation involving the storage device has been performed. The recoverability action may include performing a backup operation of data objects stored on the storage device, while a backup copy of the data objects is created on a different storage device.

In yet another aspect, a disclosed computer-readable memory media may include executable instructions for determining a recoverability state of a storage device. The instructions may be executable to receive user input indicating at least one recoverability parameter associated with the storage device, calculate a recoverability index value for the storage device based on the at least one recoverability parameter, and trigger a recoverability action for data objects stored on the storage device based on the recoverability index value. The recoverability index value may depend on a physical attribute of the storage device or a logical attribute of the storage device. The recoverability index value may depend upon a location of a previously created backup copy of data objects stored on the storage device. The recoverability index value may depend upon an amount of data associated with data objects stored on the storage device that have been modified subsequent to a prior backup operation on the storage device. The recoverability index value may depend upon a number of data objects stored on the storage device that have been modified subsequent to a prior backup operation on the storage device. The recoverability index value may depend upon a number of access operations performed on data objects stored on the storage device. The recoverability index value may depend on a user-defined priority of data objects, a user-defined location of data objects, or a user-defined selection of specific data objects. The recoverability index value may depend upon a time period between access operations associated with data objects stored on the storage device. The recoverability index value may depend upon a number of previous versions of individual data objects stored on the storage device.

In some embodiments, recovery actions may include automatically backing up data objects indicated by a user and/or backing up data objects not indicated by a user. These embodiments, may employ rules for backing up user indicated vs. non indicated data objects based on factors such as the timing of a particular backup, the frequency of backup events, storage space utilization, storage allocation overrides.

In certain embodiments, the data objects may include data files and directories created by a file system installed on the storage device. The data objects may include addressable storage locations on the storage device.

In the following description, details are set forth by way of example to facilitate discussion of the disclosed subject matter. It should be apparent to a person of ordinary skill in the field, however, that the disclosed embodiments are exemplary and not exhaustive of all possible embodiments.

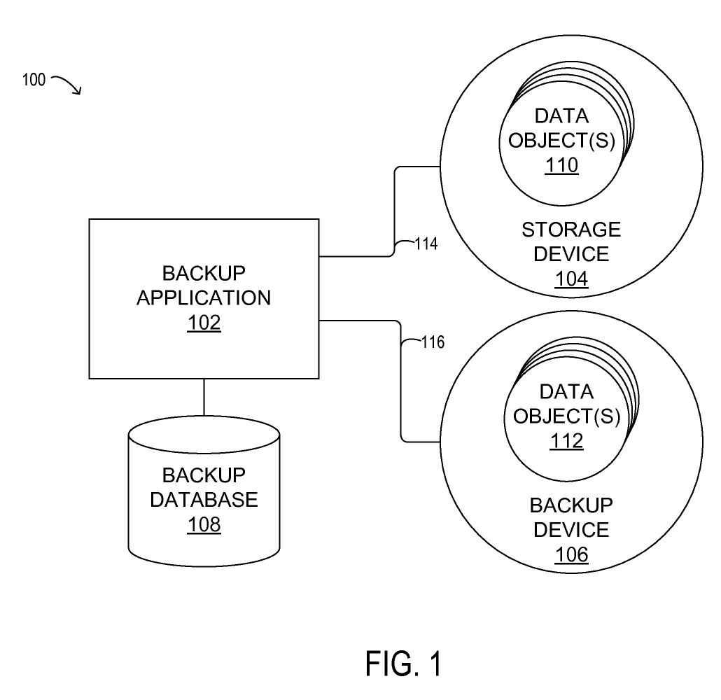

Referring now to FIG. 1, a block diagram of selected elements of an embodiment of backup system 100 are presented. Backup system 100 is depicted in generalized form for clarity and is implicitly associated with a computer system (not shown in FIG. 1). Backup system 100 includes backup application 102, which may be configured to execute the various operations and methods described herein. In particular, backup application 102 may be configured to perform backup operations, calculate a recoverability index, and perform recoverability actions, among other functions.

In FIG. 1, backup system 100 also includes storage device 104, on which a plurality of data objects 110 may be stored. Backup application 102 may be configured to access data objects 110 via storage device 104. Storage device 104 may be coupled to the computer system (not shown in FIG. 1), which backup application 102 is configured to operate with. In certain embodiments, backup application 102 may be executed on the same computer system that storage device 104 is coupled to, that is, connection 114 may represent an internal connection in the computer system. In different embodiments, backup application 102 may access storage device 104 via a network connection, represented by connection 114. Connection 114 may include private and/or public networks, such as the Internet. Although depicted as a unitary structure in FIG. 1 for clarity, storage device 104 may represent a plurality of individual storage devices, which may embody different types of storage mediums configured to store various data objects 110. Individual storage devices may be associated with individual recoverability parameters, and may so make individual contributions to the recoverability index.

With regard to a backup operation performed by backup application 102, data objects 110 represent original data for which a backup copy is desired. Backup application 102 may monitor data objects 110 for calculating the recoverability index and/or for performing recoverability actions. Data objects 110 may include various kinds of data, including, but not limited to: user data, documents, application programs, operating system files, hardware drivers, storage partitions, and file system objects. Certain data objects 110 may be continually accessed by active processes on the computer system (not shown in FIG. 1) coupled to storage device 104. Thus, at any given moment in time, particular data objects 110 may be created, modified, or deleted.

In FIG. 1, backup application 102 is also depicted accessing backup device 106. In certain embodiments, backup device 106 is also a storage device, similar to storage device 104. For example, backup device 106 may be directly coupled to the computer system via connection 116, which may represent a local connection to the computer system. In other embodiments, at least a portion of backup device 106 may be a different kind of a storage device and may be physically located at a remote location from storage device 104. In certain embodiments, backup device 106 may be accessed via a network connection, represented by connection 116. Connection 116 may include private and/or public networks, such as the Internet. During a backup operation, backup application 102 may be configured to copy original data from storage device 104 to backup device 106.

As shown in FIG. 1, data objects 112 stored on backup device 106 represent a backup copy of data objects 110 (i.e., the original data) stored on storage device 104. In certain embodiments, data objects 112 may be exact representations of corresponding data objects 110 representing original data. In other instances, data objects 112 may represent information from data objects 110 in a modified form or alternative format, for example in compressed or encrypted form. After a backup operation has been performed, data objects 112 may be used to restore or recover data objects 110.

Also depicted in FIG. 1 is a backup database 108, which may be accessible to backup application 102. In particular embodiments (not shown in FIG. 1), backup device 106 and backup database 108 may be integrated together. Backup application 102 may store information about storage device 104 and backup operations associated with storage device 104 using backup database 108. In particular, backup application 102 may store information in backup database 108 that is usable to calculate the recoverability index. For example, backup application 102 may store information associated with individual recoverability parameters, which are used to calculate the recoverability index, in backup database 108. In operation, backup application 102 may record computer system activity associated with data objects 110 in backup database 108, in addition to storing a backup copy of data objects 110 as data objects 112. Backup application 102 may then access backup database 108 to retrieve or interpret recoverability parameters. Backup application 102 may then further calculate a current recoverability index for storage device 104, representative of the recoverability of the computer system (not shown in FIG. 1). Based on the value of the recoverability index, backup application 102 may perform recoverability actions, as will be described in detail herein.

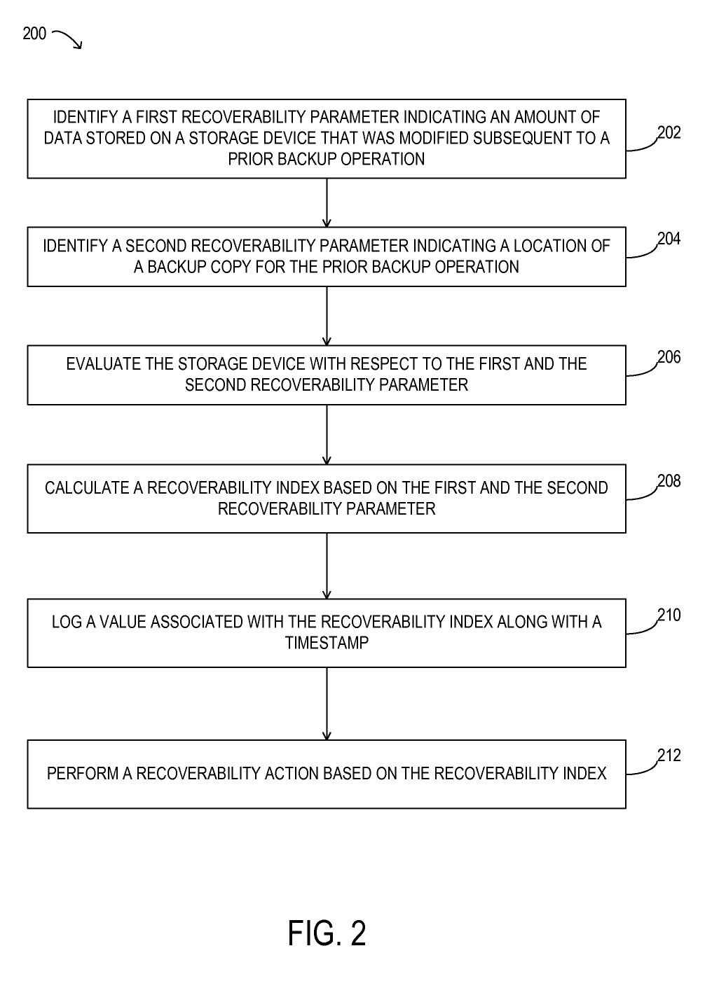

Turning now to FIG. 2, a flow diagram of selected elements of an embodiment of backup method 200 is illustrated. Backup method 200 may be executed by a backup application, such as backup application 102 (see FIG. 1) for generating a recoverability index and for performing a recoverability action, as will be described in detail below. It is noted that in different embodiments, operations in backup method 200 may be omitted, repeated, or rearranged, as desired. For example, operations 202-208 in method 200 may be continually repeated to provide a currently updated recoverability index. It is further noted that, although backup method 200 is illustrated by two explicit recoverability parameters for clarity, in other embodiments, method 200 may be implemented using varying numbers of recoverability parameters to calculate a recoverability index, as desired.

A first recoverability parameter indicating an amount of data stored on a storage device that was modified subsequent to a prior backup operation may be identified (operation 202). The first recoverability parameter may be a user-defined parameter, which is based on user input received from a user to configure a backup application, such as backup application 102 (see FIG. 1). The amount of susceptible data, i.e., the amount of data that is modified-but-not-backed-up, stored on the storage device may be indicated as an absolute value, e.g., by the number or size of susceptible data objects stored on the storage device. Alternatively, the first recoverability parameter may be based on the amount of susceptible data express in relative terms, e.g., as a percentage of the total available storage capacity. The amount of data may refer to all data objects stored on the storage device, or may be selective for particular data objects stored on the storage device. The amount of data modified since the previous backup operation may represent the amount of data susceptible to loss, and thus be positively correlated with risk of data loss. Accordingly, the first recoverability parameter may represent the risk of losing modified original data in the recoverability index. Recoverability actions based on the recoverability index may then be chosen to mitigate such risks.

The prior backup operation may refer to a successfully completed backup operation to create a backup copy of original data objects stored on the storage device. It is noted that a backup operation may include verification that the backup copy accurately corresponds to the original data, for example, by comparing each data object in the backup copy with the corresponding data object in the original data. It is further noted that a backup operation may record a snapshot of a state of the storage device at a time when the backup operation was performed.

Next, a second recoverability parameter indicating a location of a backup copy for the prior backup operation may be identified (operation 204). The location of the backup copy may describe a location of a backup device and/or the type of backup device, which may reflect various amounts of risk associated with the security of the backup copy. By including an indication of the backup copy location in a recoverability parameter, the recoverability index may reflect this location risk, while selected recoverability actions based on the recoverability index may reduce, or compensate for, such risks. Identifying the recoverability parameter may include generating a criterion list depending on the location and/or type of backup device, resulting in different values for the second recoverability parameter. For example, a removable optical media serving as the backup device may indicate a different recoverability parameter for the second recoverability parameter than a hard disk. In another example, an internal backup device may indicate a different recoverability parameter than an external backup device.

The storage device may then be evaluated with respect to the first and the second recoverability parameter (operation 206). In operation 206, evaluating the first and the second recoverability parameter may include determining a value for each parameter, and storing the values in a backup database, such as backup database 108 (see FIG. 1). In certain embodiments, operation 206 may be performed in an event-driven manner, based on events or actions occurring on the computer system or the storage device. The events may be user events, directly resulting from user input to the computer system, or driven by processes executing on the computer system absent direct user input. In certain embodiments, operation 206, along with other operations in backup method 200, are executed in a regular or irregular, repetitive manner.

A recoverability index may be calculated based on the first and the second parameters (operation 208). The recoverability index may include weightings or logical evaluations of individual recoverability parameters. In one exemplary embodiment, the first and the second recoverability parameter may each contribute to 50% of the recoverability index. In this example, the first recoverability parameter may provide a value that decreases linearly with an increasing amount of modified data from 50% to 0%, while the second recoverability parameter may only provide the values 0%, 25% and 50%, as given by a criteria list for storage locations. Other examples using different numbers and types of recoverability parameters, and in particular more complex conditional evaluations of recoverability parameters, may be implemented in various embodiments.

A value associated with the recoverability index may be logged along with a timestamp (operation 210). In certain embodiments, the actual recoverability index value is logged. In different implementations, other values, such as recoverability parameter values used to calculate the recoverability index, may be logged. The timestamp may reflect an absolute or relative time associated with the recoverability index. The logging in operation 210 may be performed using a backup database, such as backup database 108 (see FIG. 1). It is noted that operation 210 may be repeated on a regular or event-driven basis, as desired, to generate a historical log of at least one value associated with the recoverability index. The generated historical log may further be used for trend analysis, or may serve as the basis for a recoverability parameter, which may provide a recursive element in the calculation of the recoverability index. It is further noted that the historical log may include additional values or information not directly related to the recoverability index, but which may be pertinent to backup operations.

A recoverability action based on the recoverability index may be performed (operation 212). In particular embodiments, at least one recoverability action may be initiated in response to the recoverability index reaching a predetermined threshold value. A recoverability action may include a series of individual actions, or sequence of events, that improve, or lead to improving, the recoverability of the computer system by reducing the risk of data loss for data objects associated with the computer system. As noted previously, a plurality of threshold values may be defined, which establish certain operational zones for the recoverability index. As long as the recoverability index remains within the threshold values for a given zone, the corresponding recoverability actions for that zone may be executed.

In various embodiments, different recoverability actions may be predetermined. Recoverability actions may be established in response to user input to a backup application, such as backup application 102 (see FIG. 1). One recoverability action may involve outputting the recoverability index, which may include displaying the recoverability index to a user, outputting the recoverability index to an application or executable process, transmitting the recoverability index over a network, generating a hardcopy of the recoverability index, or a combination thereof. Another recoverability action may involve issuing a warning or alerting message. The warning message may be displayed to a user, output as a multimedia signal (e.g., visual, audio, tactile, olfactory, etc.), transmitted over a network, output to an application or executable process, or a combination thereof Still another recoverability action may involve suggesting and/or confirming a further recoverability action, or automatically initiating a further recoverability action. The operations associated with suggesting and confirming may involve user interface elements, such as interactive user dialog response elements generated by executable code, which may include multimedia content (e.g., audio, images, video, text, animation, etc.). Certain recoverability actions may include delays or wait intervals, which are predetermined in duration, or which depend upon an external event to initiate and/or terminate. A recoverability action may include blocking user input associated with the storage device, or certain data objects. The blocking may be continued until a further recovery action is taken, such as performing a backup operation involving the storage device, or the affected data objects.

A further recoverability action may include performing a backup operation. The backup operation may be limited to a particular storage device and/or to a particular set of data objects. In some embodiments, a number of different recoverability actions corresponding to different backup operations may be configured and performed. Performing the backup operation may include scheduling a new backup operation, or changing the priority of a scheduled backup operation. In particular embodiments, the backup operation may be subject to user confirmation prior to initiation. In other implementations, the backup operation may be performed automatically.

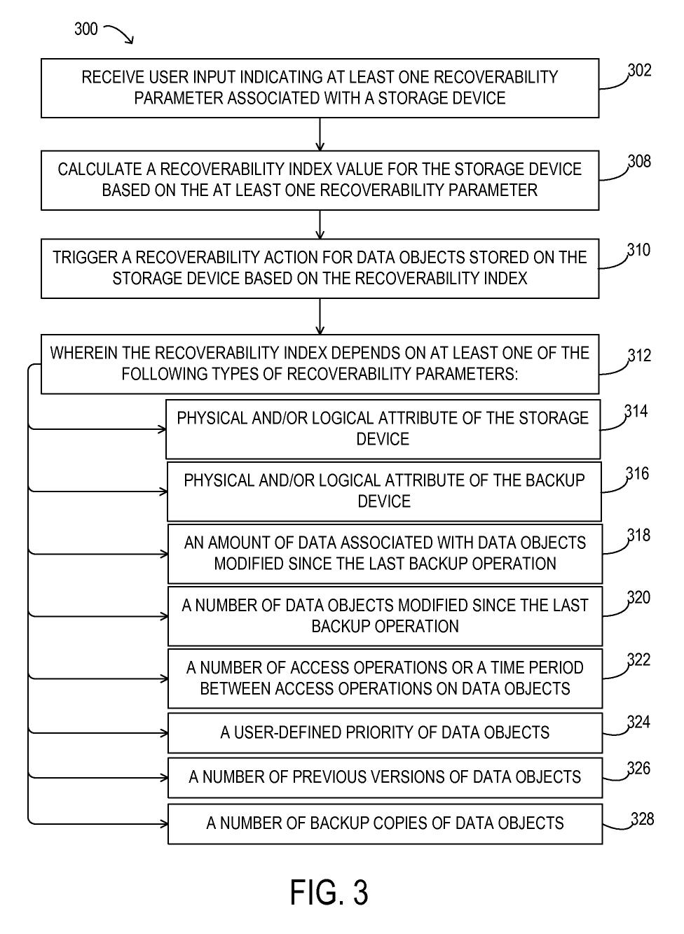

Turning now to FIG. 3, a flow diagram of selected elements of an embodiment of backup method 300 is illustrated. Backup method 300 may be executed by a backup application, such as backup application 102 (see FIG. 1). It is noted that in different embodiments, operations in backup method 300 may be omitted, repeated, or rearranged, as desired.

In method 300, user input indicating at least one recoverability parameter associated with a storage device may be received (operation 302). The user input may be received by a user of a backup application, such as backup application 102 (see FIG. 1). The user input may further specify the relationship between the at least one recoverability parameter and a recoverability index. The user input may further specify relative weightings between individual recoverability parameters. The recoverability parameters in method 300 may include the various types of recoverability parameters specified above with respect to method 200 (see FIG. 2). In certain embodiments, different recoverability parameters for a plurality of storage devices coupled to a computer system are calculated during operation 302, for example, by repeating certain portions of operation 302.

A recoverability index may then be calculated for the storage device based on the at least one recoverability parameter (operation 304). The recoverability index may be calculated similar to the recoverability index described above with respect to operation 208 (see FIG. 2). A recoverability action for data objects stored on the storage device may be triggered based on the recoverability index (operation 310). The recoverability action may include any of the recoverability actions described above with respect to operation 212 (see FIG. 2).

The recoverability index may depend on at least one of a variety of different types of recoverability parameters (operation 312). A recoverability parameter may describe a physical and/or logical attribute of the storage device (operation 314). Examples of attributes of the storage device may include whether the storage device: is internal or external, uses fixed or removable storage media, is solid-state or mechanical, is magnetic or optical or a combination thereof, is permanent or re-writable, or is accessible via a local interface or a remote network connection, or combinations thereof. Attributes of the storage device may further include capacity, type of partition, formatting, type of file system, level of redundancy, location, performance, or combinations thereof A recoverability parameter may describe a physical and/or logical attribute of the backup device (operation 316). Examples of attributes of the backup device may be substantially similar to those described above for a storage device. One physical attribute may be a location of a previous backup copy, or a location of a backup device storing data objects of the backup copy. A recoverability parameter may describe an amount of data associated with data objects modified since the last backup operation (operation 318). The amount of data may refer to absolute sizes of data objects, relative sizes of data objects, an aggregate size of a plurality of data objects, or various combinations thereof in different exemplary implementations. A recoverability parameter may describe a number of data objects modified since the last backup operation (operation 320). The number of data objects may be represented relative to a total number of data objects associated with the backup operation. A recoverability parameter may describe a number of access operations or a time period between access operations on data objects (operation 322). An access operation on a data object may include operations to open, read, write, or close a data object. Access operations may further include copy, move, delete, or erase operations. An access operation may be performed by a process executing on the computer system. A recoverability parameter may describe a user-defined priority of data objects (operation 324). A user may specify certain data objects for a higher or lower level of priority, such that a modification of such prioritized data objects alters a value associated with the value of the recoverability parameter. A recoverability parameter may describe a number of previous versions of data objects (operation 326). In certain embodiments, previous backup versions of data objects may be maintained in the backup copy. A recoverability parameter may include information about the previous versions. A recoverability parameter may describe a number of backup copies of data objects (operation 328). A greater number of backup copies may provide higher recoverability through increased redundancy, which may be reflected in a recoverability parameter. A recoverability parameter may be indicative of an integrity of backup data. For example, backup data may be stored with parity, checksum, and/or other types of error detection, error correction information and the integrity of the backup data in such cases may refer to whether the error detection/error detection information indicates errors.

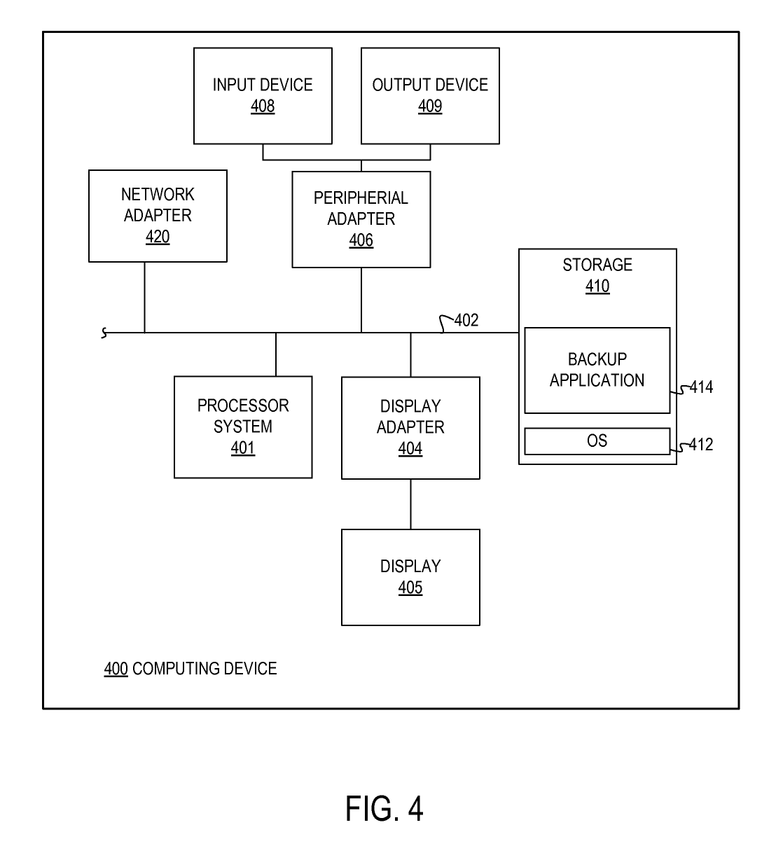

Referring now to FIG. 4, a block diagram illustrating selected elements of an embodiment of a computing device 400 is presented. In various embodiments, computing device 400 may represent an instance of the computer system to which a storage device, such as storage device 104 (see FIG. 1), may be coupled, and on which a backup operation, according to the methods described herein, may be performed.

In the embodiment depicted in FIG. 4, computing device 400 includes processor 401 coupled via shared bus 402 to storage media collectively identified as storage 410. Computing device 400, as depicted in FIG. 4, further includes network adapter 420 that interfaces computing device 400 to a network (not shown in FIG. 4). In some embodiments suitable for use in backup systems, computing device 400, as depicted in FIG. 4, may include peripheral adapter 406, which provides connectivity for the use of input device 408 and output device 409. Input device 408 may represent a device for user input, such as a keyboard or a mouse, or even a video camera. Output device 409 may represent a device for providing signals or indications to a user, such as loudspeakers for generating audio signals.

Computing device 400 is shown in FIG. 4 including display adapter 404 and further includes a display device or, more simply, a display 405. Display adapter 404 may interface shared bus 402, or another bus, with an output port for one or more displays, such as display 405. Display 405 may be implemented as a liquid crystal display screen, a computer monitor, a television or the like. Display 405 may comply with a display standard for the corresponding type of display. Standards for computer monitors include analog standards such as video graphics array (VGA), extended graphics array (XGA), etc., or digital standards such as digital video interface (DVI), high definition multimedia interface (HDMI), among others. A television display may comply with standards such as National Television System Committee (NTSC), Phase Alternating Line (PAL), or another suitable standard.

Display 405 may include an output device 409, such as one or more integrated speakers to play audio content, or may include an input device 408, such as a microphone or video camera. In some embodiments, computing device 400 may be configured without (i.e., may exclude) at least one of input device 408, output device 409, and display 405. Although FIG. 4 depicts a system with input/output resources including a display device, other embodiments of computing device 400 may be implemented without any user input device and/or display device.

Storage 410 encompasses persistent and volatile memory media, fixed and removable memory media, and magnetic and semiconductor memory media. Storage 410 is operable to store instructions, data, or both. Storage 410 as shown includes sets or sequences of instructions, namely, an operating system 412, and backup application 414. Operating system 412 may be a UNIX or UNIX-like operating system, a Windows® family operating system, or another suitable operating system. It is noted that in different embodiments backup application 414 may represent different functionality, such as processor useable instructions, provided by backup application 102 (see FIG. 1).

To the maximum extent allowed by law, the scope of the present disclosure is to be determined by the broadest permissible interpretation of the following claims and their equivalents, and shall not be restricted or limited to the specific embodiments described in the foregoing detailed description.

What is claimed is:

1. A method for determining a recoverability state of a storage device, comprising:
identifying at least one recoverability parameter;
evaluating the storage device with respect to the recoverability parameter;
calculating a recoverability index based at least in part on the recoverability parameter, the recoverability index indicating the recoverability state of the storage device; and
performing a recoverability action based on the recoverability index.

2. The method of claim 1, wherein the recoverability action includes at least one of: outputting the recoverability index, displaying the recovery index, issuing a warning message, suggesting a further recoverability action, confirming a further recoverability action, and performing a backup operation.

3. The method of claim 1, wherein the storage device is coupled to a computer system.

4. The method of claim 1, wherein said storage device comprises a first storage device and said performing further includes:
performing a backup operation of data objects stored on the first storage device, the backup operation including generating a backup copy of the data objects.

5. The method of claim 4, wherein the backup copy is stored on a second storage device different from the first storage device.

6. The method of claim 1, wherein said performing is initiated based on a difference between a threshold value and the value associated with the recoverability index.

7. The method of claim 6, wherein a plurality of different threshold values are respectively associated with individual recoverability actions.

8. The method of claim 1, wherein said calculating is performed at regular intervals.

9. The method of claim 1, wherein the recoverability action includes blocking user input associated with the storage device until a backup operation involving the storage device has been performed.

10. The method of claim 1, further comprising:
logging the value associated with the recoverability index along with a timestamp.

11. The method of claim 1, wherein said calculating includes weighting a first recoverability parameter relative to a second recoverability parameter.

12. The method of claim 1, wherein said identifying comprises identifying a plurality of recoverability parameters, wherein a first recoverability parameter is indicative of a location of a previously created backup copy of data objects stored on the storage device, and wherein a second recoverability parameter is indicative of a number of data objects stored on the storage device that have been modified subsequent to a prior backup operation on the storage device.

13. A computer system comprising:
a processor; and
memory media accessible to the processor, including processor executable instructions to:
identify at least one recoverability parameter associated with a storage device configured for storing data objects;
calculate a recoverability index value for the storage device based on the at least one recoverability parameter; and
trigger a recoverability action for data objects stored on the storage device based on the recoverability index value.

14. The computer system of claim 13, wherein the recoverability action includes processor executable instructions to execute at least one of: output the recoverability index, display the recovery index, issue a warning message, suggest a further recoverability action, confirm a further recoverability action, perform a backup operation, and block user input associated with the storage device until a backup operation involving the storage device has been performed.

15. The computer system of claim 13, wherein the recoverability action includes processor executable instructions to perform a backup operation of data objects stored on the storage device, wherein a backup copy of the data objects is created on a different storage device.

16. Computer-readable memory media, including executable instructions for determining a recoverability state of a storage device, said instructions executable to:
receive user input indicating at least one recoverability parameter associated with the storage device;
calculate a recoverability index value for the storage device based on the at least one recoverability parameter; and
trigger a recoverability action for data objects stored on the storage device based on the recoverability index value.

17. The memory media of claim 16, wherein the recoverability index value depends upon at least one of: a physical attribute of the storage device and a logical attribute of the storage device.

18. The memory media of claim 16, wherein the recoverability index value depends upon a location of a previously created backup copy of data objects stored on the storage device.

19. The memory media of claim 16, wherein the recoverability index value depends upon an amount of data associated with data objects stored on the storage device that have been modified subsequent to a prior backup operation on the storage device.

20. The memory media of claim 16, wherein the recoverability index value depends upon a number of data objects stored on the storage device that have been modified subsequent to a prior backup operation on the storage device.

21. The memory media of claim 16, wherein the recoverability index value depends upon a number of access operations performed on data objects stored on the storage device.

22. The memory media of claim 16, wherein the recoverability index value depends upon at least one of: a user-defined priority of data objects, a user-defined location of data objects, and a user-defined selection of specific data objects.

23. The memory media of claim 16, wherein the recoverability index value depends upon a time period between access operations associated with data objects stored on the storage device.

24. The memory media of claim 16, wherein the recoverability index value depends upon at least one of: a number of previous versions of individual data objects stored on the storage device, and a number of backup copies of data objects.

25. The memory media of claim 16, wherein the data objects include data files and directories created by a file system installed on the storage device.

26. The memory media of claim 16, wherein the data objects include addressable storage locations on the storage device.
